(19) United States
(12) Patent Application Publication
(10) Pub. No.: US 2014/0267096 A1
(43) Pub. Date: Sep. 18, 2014

(54) PROVIDING A HYBRID TOUCHPAD IN A COMPUTING DEVICE

(71) Applicant: Xu Han, Shanghai (CN)

(72) Inventor: Xu Han, Shanghai (CN)

(21) Appl. No.: 13/997,674

(22) PCT Filed: Mar. 14, 2013
(86) PCT No.: PCT/CN2013/072597

§ 371 Date: Jun. 25, 2013

(51) Int. Cl. G06F 3/041

(52) U.S. Cl. CPC G06F 3/0416
USPC 345/173

(57) ABSTRACT

In an embodiment, a system includes a processor to execute instructions and a touchpad to receive touch data from a user, where the touchpad is coupled to the processor and includes an engine to identify the touch data as a touch event or a mouse event and to communicate the identification of the touch event or the mouse event to an operating system (OS) that executes on the processor. Other embodiments are described and claimed.

### TECHNICAL FIELD

Embodiments relate to computing devices including touchpad functionality.

### BACKGROUND

Many computing systems and particularly portable systems such as laptops, smartphones and so forth provide some manner of human input by way of touch functionality. Some of these systems include touchpads, which historically are used to take the place of a mouse.

More recently, operating systems (OSs) such as the Microsoft WINDOWS 8™ OS have been introduced that include functionality to handle touch panel inputs for user inputs received via a touch panel such as a computer monitor, a touch panel of a smartphone, laptop computer, tablet computer or other such device. However, available touchpads are typically not configured for handling touch panel-based gesture inputs.

To date, so-called filter drivers have been provided to filter inputs received from a touchpad and use mouse-driven events to implement a gesture operation. For example, to pinch zoom in/out of a picture, a pinch in a touch panel or a touchpad may occur. Differences in these methods are: a touch panel generates a native touch event (GID_ZOOM); and a touchpad generates a mouse event such as a mouse wheel event. Filtering such mouse events suffers from various drawbacks including: latency required for processing; complex implementation; and inability to translate mouse events to touch panel gestures (instead simply translating mouse wheel events).

### BRIEF DESCRIPTION OF THE DRAWINGS

FIG. 1 is a block diagram of an architecture of a computing device that includes a touchpad in accordance with an embodiment of the present invention.

FIG. 2 is a block diagram of further details of a hybrid touchpad in accordance with an embodiment of the present invention.

FIG. 3 is a flow diagram of a method for handling user input using a touchpad in accordance with an embodiment of the present invention.

FIG. 4 is an illustration of an embodiment of a computing device in accordance with an embodiment of the present invention.

FIG. 5 is a block diagram of components present in a computer system in accordance with an embodiment of the present invention.

FIG. 6 is a block diagram of an example system with which embodiments can be used.

### DETAILED DESCRIPTION

In various embodiments, a touchpad for a computing device can be provided with hybrid functionality to enable the touchpad to report user inputs as either being of a single touch variety such as of a conventional touchpad (also referred to herein as a mouse event) or of a multi-touch or other advanced gesture input variety (referred to herein as a touch panel event). By providing this functionality in hardware associated with the touchpad, complexities involving hardware and software outside of the touchpad in attempting to translate input data received from a touchpad to gesture inputs or multi-touch inputs can be reduced.

To this end, embodiments provide a touchpad including hardware that can perform identification of user inputs as being of a single touch event (handled as a conventional touchpad or mouse event), a multi-touch gesture (handled as a touch panel event), or as a boundary sliding gesture (also handled as a touch panel event). The hardware can include a processor that is configured by firmware to be logically partitioned into a logical touchpad processor and a logical touch panel processor, in an embodiment. As such, a touchpad in accordance with an embodiment of the present invention can simulate both a logical touchpad and a logical touch panel with a single touchpad device. Furthermore, this firmware may be configured to operate such that when a user input is received via the touchpad, the firmware can distinguish touchpad events from touch panel events and dispatch the inputs to the appropriate type of processor (e.g., logical touchpad processor or logical touch panel processor). Although described in this embodiment as being firmware implemented, understand the scope of the present invention is not limited in this regard and in other embodiments, another control engine or logic may enable logical partitioning of a hardware processor of the touchpad.

Referring now to FIG. 1, shown is a block diagram of an architecture of a computing device 100 that includes a touchpad 110 in accordance with an embodiment of the present invention. Although the architecture shown in FIG. 1 is for a Microsoft Windows™ OS-based system, understand the scope of the present invention is not limited in this regard. As shown in FIG. 1, computing device 100 may be any type of computing device that includes a touchpad. Such computing devices can be desktop computer systems, laptops, Ultrabook™ computers, tablet computers, smartphones and so forth. In general, touchpad 110 is configured as a hybrid touchpad that includes a logical touchpad processor 116 and a logical touch panel processor 118, both of which are configured to execute on underlying hardware of the touchpad, shown as a microcontroller 117. In an embodiment, these logical processors may be implemented as firmware of the touchpad. Although shown as a microcontroller, understand that another processing logic such as low power processor or an in-order processor may instead be associated with the touchpad, in some embodiments. These logical processors may be configured via a hybrid engine 115, which in an embodiment may be implemented using firmware that executes on microcontroller 117 or other processing logic of touchpad 110.

As seen in FIG. 1, touchpad 110 communicates with a software stack, generally formed of a kernel layer 120 which corresponds to an OS, and a user layer 130 which corresponds to one or more user-controlled applications that execute on kernel layer 120. In an embodiment, both kernel layer 120 and user layer 130 may execute on a processor, e.g., a multicore processor of computing device 100.

Kernel layer 120 includes a variety of different drivers and other agents. To receive communications from touchpad 110, a communication stack 122 is present. In the embodiment shown, communication stack 122 is a universal serial bus (USB)/inter-integrated circuit (I²C) stack. This stack may be implemented using one or more drivers in an embodiment.

Communication stack 122 in turn provides information to a human interface device (HID) class driver 124 which in turn is in communication with a HID parser driver 125. Using these combinations of drivers, the type of input received via communication stack 122 can be determined. For purposes of inputs received via hybrid touchpad 110, HID class driver 124 can thus determine the appropriate agent to receive a given type of user input.

As seen in the embodiment of FIG. 1, for single touch-related data corresponding to mouse events, the data is provided to a mouse HID driver 128a that in turn is in communication with a mouse class driver 128b. Drivers 128a and 128b are used to handle and process mouse reported raw data. In turn, when input data is determined to be from a keyboard (from a corresponding keyboard interface (not shown in FIG. 1)), the data is provided to a keyboard HID driver 126a that in turn is communication with a keyboard class driver 126b. Drivers 126a and 126b are used to handle and process keyboard reported data. Instead, when incoming data is determined to be a hot button selection, e.g., from a keyboard or other user input device, such data can be passed directly to user layer 130.

Finally, when incoming data is determined to be touch data (which in this embodiment is determined in touchpad 110 directly), HID class driver 124 can directly dispatch the touch data to a Windows™ driver 132, which is a session driver that further processes the touch data in kernel layer 120, to place it in condition to be provided to a given driver or other code of user layer 130 to further process the data. Although shown at this high level in the embodiment of FIG. 1, understand the scope of present invention is not limited in this regard.

Referring now to FIG. 2, shown is a block diagram of further details of a hybrid touchpad in accordance with an embodiment of the present invention. As shown in FIG. 2, touchpad 200 includes a firmware application layer 205 having various components. In the embodiment shown, layer 205 includes a logical touchpad processor 210 having a touchpad event processor 212 and a touchpad data reporter 214. As seen, logical touchpad processor 210 is in communication with a hybrid engine 230 via a touchpad channel 215. Understand that in various embodiments this logical touchpad processor may execute on a physical processor of the touchpad (e.g., a microcontroller or other processing logic), which can be virtually partitioned into the logical touchpad processor and a logical touch panel processor via a hybrid engine 230, which may be implemented by firmware of the touchpad, in an embodiment. In turn, logical touch panel processor 220 includes a touch panel event processor 222 and a touch panel data reporter 224. Touch panel processor 220 is in communication with hybrid engine 230 via a touch panel channel 225.

As further seen in FIG. 2, firmware application layer 205 includes an input/output (10) manager 232 to manage communications to provide raw data from the touchpad to an OS. Also present in firmware application layer 205 is an event manager 234 that may receive various events including input-related events, as well as handling events received from the OS such as power management events.

Still referring to FIG. 2, raw data obtained and processed within firmware application layer 205 is communicated through a protocol stack 240. In the embodiment shown, protocol stack 240 includes a HID device stack 242, a USB device stack 244 and an I²C device stack 246. In general, this protocol stack enables handling of incoming communications from the touchpad according to a particular interconnect communication protocol with which the touch data is sent. In turn, the data can be provided to a hardware driver layer 260 that in the embodiment shown includes a USB driver 262, an I²C driver 264 and a hybrid touch sensor driver 266 to receive touched state information from the touch surface.

To provide for core services for the touchpad, a core services layer 250 is present. As seen, this layer includes a scanner 252, an interrupt manager 254, a timer 256, and a power manager 258. Hardware 230 to perform touch processing includes, in an embodiment a scan line 274 and a USB/I²C interface 272. Interface 272 is the device's physical interface to connect to a host system, and scan line 274 is used to connect to the touch sensor and receive the finger touch state.

Referring now to FIG. 3, shown is a flow diagram of a method for handling user input using a touchpad in accordance with an embodiment of the present invention. As shown in FIG. 3, method 300 may be performed by various logic of a hybrid touchpad as described herein. Method 300 begins by starting firmware of the touchpad (block 305). This startup may occur on system initialization and any reset of the system. Next at block 310 the firmware may be initialized, which may include initialization of an initial timer, touch sensor, and USB/I²C interface. Next at block 315 the logical touchpad processor can be initialized and registered with the OS. In an embodiment, this initialization and registration may include enumeration of a touchpad (mouse) device to the OS. Similarly, at block 320 the logical touch panel processor may be initialized and registered. This initialization and registration may proceed in substantially the same manner as logical touchpad processor initialization and registration to enumerate a touch panel device to the OS. At this point, the hybrid touchpad is configured and ready to receive and handle incoming user inputs during normal system operation.

Still referring to FIG. 3, control next passes to block 330 where touch data may be received. In general, this touch data received from a user can be of several different forms, including a single touch where the user seeks to provide a mouse-like input, a multi-touch gesture where the user imitates various gesture input mechanisms available on a touch panel, and a boundary sliding event where a user seeks to cause a display change in accordance with the gesture.

Using a hybrid engine in accordance with an embodiment of the present invention, a destination logical processor of the hybrid touchpad for this touch data can be determined by analysis of the touch data in the hybrid engine. As seen in FIG. 3, it can be determined at diamond 340 whether the touch data corresponds to a single finger touch. If not, control passes to block 350 where the data can be dispatched to a logical touch panel processor. Otherwise, if the touch data is a single finger touch, control passes instead from diamond 340 to diamond 370 to determine whether the touch data corresponds to boundary sliding data. In an embodiment, this determination can be based on whether a point of an edge line was touched, and a line extended from the point. If so, control passes also to block 350. Otherwise, the touch data is thus a single finger user touch intended to replicate mouse functionality. Accordingly, control passes to block 380 where the touch data can be dispatched to a logical touchpad processor.

From both of blocks 350 and 380 control passes to block 360 where the given touch data can be processed. In an embodiment, this processing may include reporting multi-point data according to an OS touch panel protocol, such that the OS may use a built-in driver to process these data. In this way, embodiments can support gesture inputs natively. In contrast, with a filter driver implementation, multi-point data is reported via a private protocol to the filter driver, the filter driver processes this data and translates events to mouse events, which does not support gesture natively.

That is, different processing of received data may occur depending upon whether the event is indicated to be a mouse-based event or a touch panel-based event. To this end, embodiments may differently process the user input data depending on whether it is a touchpad event or touch panel event. Specifically, different positioning information can be communicated as part of the touch data depending on the type of event. For single touch user input, offset positioning with regard to location on the touchpad may be communicated. More specifically the processed touch data may include position information having an offset with respect to an origin of the touchpad. Instead for touch panel user input, absolute positioning of the touch input may be with regard to a location on an associated display of the system. Note that this display may not be a touch panel, as instead touch panel functionality such as present in a given OS is simulated via user input on a hybrid touchpad as described herein. Thus for such events, the processed touch data may include absolute position information that associates the touch data with a position on a display of the system.

Note that for touch panel data, the processing performed in the logical touch panel processor is the complete processing needed in order to obtain the raw touch panel data that can then directly be provided to a built-in touch driver of the OS. For example with reference back to FIG. 1, the touch panel raw data report path is through the following blocks: 118-122-124-132. As such, the need for any filtering within a third party kernel or user mode driver is avoided, reducing latency and providing for smoother flow. This filtered path in contrast, in FIG. 1, includes blocks 116-122-124-128a-128b, such that the additional software layer processing consumes higher latency.

One example of a smooth flow is for a user providing multi-finger gesture input to replicate desired movement on a display, e.g., to scroll pages or enlarge or minimize a particular portion of an image on the display, can occur smoothly without undesired latency. Embodiments further reduce processor utilization and accordingly power consumption by avoiding the need for execution of one or more filter drivers.

Still referring to FIG. 3, upon completion of processing, the data is sent to the OS for further processing. Control then returns to block 330 for receipt of further touch data. Note that although shown with this particular implementation in the embodiment of FIG. 3, the scope of the present invention is not limited in this regard.

Referring now to Table 1, shown is a summary of operating parameters using a hybrid touch panel in accordance with an embodiment of the present invention (in column A) and using a legacy touchpad that does not provide for integrated touch panel processing (in column B).

TABLE 1

| | Hybrid Touchpad | Legacy Touchpad |
|---|---|---|
| Touch Latency | 25 milliseconds (ms) | 130 ms (Mouse Event) |
| | (Touch Event) | |
| Gesture Input | Touch raw data | Private protocol reports |
| | | multi-point data by |
| | | touchpad and then |
| | | translated to mouse wheel |
| | | by add-in filter. |
| Gesture Driver | OS built-in driver | third party filter driver and |
| | | event translation |
| | | driver/application |
| Gesture Algorithm | OS built in | Third Party provided |
| Performance | Good | Bad |
| User Experience | Smooth | Slow |

As seen, using an embodiment of the present invention, a higher performance level can be achieved, including reduced touch latency while at the same time providing a smoother user experience.

Referring now to FIG. 4, an illustration of an embodiment of a computing device is illustrated. Various commercial implementations of system 400 may be provided. As one example, system 400 corresponds to an Ultrabook™, an Apple MacBook Air™, another ultralight and thin computing device, or any known and/or available ultralight, ultrathin, and/or ultraportable computing platform. As a first example, an ultraportable computing device includes any thin and/or light device capable of performing computing tasks (e.g. user input/output, execution of instruction/code, or network connection, etc.), such as a thin and/or light notebook, laptop, e-reader, tablet, and hybrid thereof (e.g. a notebook that is convertible into a tablet, e-reader, etc.).

With reference to FIG. 4, system 400, in one embodiment includes a base portion 401 which may be configured via a lightweight chassis. As one example, the base portion includes substantially all of the electronics circuitry of the system; however, this is not required as other components may be placed in different sections of system 400 (e.g., in the display 425, lid portion 402, or other known section of a ultrathin, ultralight computing device). For user interfaces, a keyboard 436 and a touchpad 430 are provided in base portion 401. Touchpad 430 is a hybrid touchpad to enable touch panel-like control as described herein. Further, any known device for providing input to a computer system or computing device may be utilized. For example, the sensors described below may be utilized in conjunction with (or in place of) a keyboard, mouse, etc. to receive input from a user and perform computing tasks. In addition, various ports for receiving peripheral devices, such as universal serial bus (USB) ports (including a USB 3.0 port), a Thunderbolt™ port, video ports (e.g. a micro high definition media interface (HDMI) or mini video graphics adapter (VGA), memory card ports such as a SD card port, and audio jack, among others) may be present on a side of the chassis (in other embodiments user-accessible ports may be present on the opposing chassis side or other surface of system 400). In addition, a power port may be provided to receive DC power via an AC adapter (not shown in FIG. 4). Note these ports are purely illustrative. As the size of ultraportable computing devices becomes smaller, fewer external ports may be provided. Instead, communication may be performed through wireless communication techniques similar to Bluetooth, Near Field Communication, Wi-Fi, sensors, etc. Moreover, power may be received through alternative connections (or even wirelessly in some embodiments).

As further seen, a lid portion 402 may be coupled to base portion 401 and may include one or more display(s) 425, which in different embodiments can be a liquid crystal display (LCD) or an organic light emitting diode (OLED). However, any display technology, such as an e-ink screen, may be utilized as display 425. Furthermore, in the area of display 425, touch functionality, in one embodiment, is provided such that a user is able provide user input via a touch panel co-located with display 425. Lid portion 402 may further include various capture devices, including a camera device 405, which is capable to capture video and/or still information. In addition, one or more microphones, such as dual microphones 406a and 406b, may be present to receive user input via the user's voice. Although shown at this location in FIG. 4, the microphone, which can be one or more omnidirectional microphones, may be in other locations.

System 400, in one embodiment, is configured with particular components and circuitry to enable a high end user experience via a combination of hardware and software of the platform. For example, using available hardware and software, perceptual computing may enable a user to interact with the system via voice, gesture, touch and in other ways. Here, different sensors are potentially included to detect, utilize, or provide sense information (e.g., visual, auditory, olfactory, kinesthetic, gustatory, 3D perception, temperature, humidity, or any other known sense). Sensors and handling of such information is discussed below in more detail.

In addition, this user experience may be delivered in a very light and thin form factor system that provides high performance and low-power capabilities, while also enabling advanced features such as instant on and instant connect (also known as Always On Always Connected), so that the system is capable of being put into a low power state (e.g., sleep mode, standby, or other known low power mode) and directly awaken and be available to the user instantly (e.g., within less than one, two, five, or seven seconds of exiting the sleep mode). Furthermore upon such wake-up the system, in one embodiment, is connected to networks such as a local network, Wi-Fi network, the Internet, etc.; providing similar performance to that available in smartphones and tablet computers, which lack the processing and user experience of a fully featured system such as that of FIG. 4. Of course, although shown at this high level in the illustration of FIG. 4, understand that additional components may be present within the system, such as loud speakers, additional displays, capture devices, environmental sensors and so forth, details of which are discussed further below.

Referring now to FIG. 5, shown is a block diagram of components present in a computer system in accordance with an embodiment of the present invention. As shown in FIG. 5, system 500 can include many different components. These components can be implemented as ICs, portions thereof, discrete electronic devices, or other modules adapted to a circuit board such as a motherboard or add-in card of the computer system, or as components otherwise incorporated within a chassis of the computer system. Note also that the block diagram of FIG. 5 is intended to show a high level view of many components of the computer system. However, it is to be understood that additional components may be present in certain implementations and furthermore, different arrangement of the components shown may occur in other implementations.

As seen in FIG. 5, a processor 510, which may be a low power multicore processor socket such as an ultra-low voltage processor, may act as a main processing unit and central hub for communication with the various components of the system. Such processor can be implemented as a system on a chip (SoC). In one embodiment, processor 510 may be an Intel® Architecture Core™-based processor such as an i3, i5, i7 or another such processor available from Intel Corporation, Santa Clara, Calif., such as a processor that combines one or more Core™-based cores and one or more Intel® ATOM™-based cores to thus realize high power and low power cores in a single SoC. However, understand that other low power processors such as available from Advanced Micro Devices, Inc. (AMD) of Sunnyvale, Calif., an ARM-based design from ARM Holdings, Ltd. or a MIPS-based design from MIPS Technologies, Inc. of Sunnyvale, Calif., or their licensees or adopters may instead be present in other embodiments such as an Apple A5 processor.

Processor 510 may communicate with a system memory 515, which in an embodiment can be implemented via multiple memory devices to provide for a given amount of system memory, and can be coupled to processor 510 via one or more memory interconnects.

To provide for persistent storage of information such as data, applications, one or more operating systems and so forth, a mass storage 520 may also couple to processor 510. In various embodiments, to enable a thinner and lighter system design as well as to improve system responsiveness, this mass storage may be implemented via a SSD. However in other embodiments, the mass storage may primarily be implemented using a hard disk drive (HDD) with a smaller amount of solid state drive (SSD) storage to act as a SSD cache to enable non-volatile storage of context state and other such information during power down events so that a fast power up can occur on re-initiation of system activities. Also shown in FIG. 5, a flash device 522 may be coupled to processor 510, e.g., via a serial peripheral interface (SPI). This flash device may provide for non-volatile storage of system software, including a basic input/output software (BIOS) as well as other firmware of the system.

Various input/output (10) devices may be present within system 500. Specifically shown in the embodiment of FIG. 5 is a display 524 which may be a high definition LCD or LED panel configured within a lid portion of the chassis. This display panel may also provide for a touch screen 525, e.g., adapted externally over the display panel such that via a user's interaction with this touch screen, user inputs can be provided to the system to enable desired operations, e.g., with regard to the display of information, accessing of information and so forth. In one embodiment, display 524 may be coupled to processor 510 via a display interconnect that can be implemented as a high performance graphics interconnect. Touch screen 525 may be coupled to processor 510 via another interconnect, which in an embodiment can be an I²C interconnect. As further shown in FIG. 5, in addition to touch screen 525, touch user input can also occur via a touchpad 530 which may be configured within the chassis and may also be coupled to the same I²C interconnect as touch screen 525. Touchpad 530 may be a hybrid touchpad that enables user inputs to simulate touch panel gesture inputs, either in the case where a touch screen is not present or where a user chooses to provide such input by way of this touchpad instead of the touch screen.

For perceptual computing and other purposes, various sensors may be present within the system and can be coupled to processor 510 in different manners. Certain inertial and environmental sensors may couple to processor 510 through a sensor hub 540, e.g., via an I²C interconnect. In the embodiment shown in FIG. 5, these sensors may include an accelerometer 541, an ambient light sensor (ALS) 542, a compass 543 and a gyroscope 544. Other environmental sensors may include one or more thermal sensors 546 which may couple to processor 510 via a system management bus (SMBus) bus, in one embodiment.

Also seen in FIG. 5, various peripheral devices may couple to processor 510 via a low pin count (LPC) interconnect. In the embodiment shown, various components can be coupled through an embedded controller 535. Such components can include a keyboard 536 (e.g., coupled via a PS2 interface), a fan 537, and a thermal sensor 539. In some embodiments, touch pad 530 may also couple to EC 535 via a PS2 interface. In addition, a security processor such as a trusted platform module (TPM) 538 in accordance with the Trusted Computing Group (TCG) TPM Specification Version 1.2, dated Oct. 2, 2003, may also couple to processor 510 via this LPC interconnect.

System 500 can communicate with external devices in a variety of manners, including wirelessly. In the embodiment shown in FIG. 5, various wireless modules, each of which can correspond to a radio configured for a particular wireless communication protocol, are present. One manner for wireless communication in a short range such as a near field may be via a near field communication (NFC) unit 545 which may communicate, in one embodiment with processor 510 via an SMBus. Note that via this NFC unit 545, devices in close proximity to each other can communicate. For example, a user can enable system 500 to communicate with another (e.g.) portable device such as a smartphone of the user via adapting the two devices together in close relation and enabling transfer of information such as identification information payment information, data such as image data or so forth. Wireless power transfer may also be performed using a NFC system.

As further seen in FIG. 5, additional wireless units can include other short range wireless engines including a WLAN unit 550 and a Bluetooth unit 552. Using WLAN unit 550, Wi-Fi™ communications in accordance with a given Institute of Electrical and Electronics Engineers (IEEE) 802.11 standard can be realized, while via Bluetooth unit 552, short range communications via a Bluetooth protocol can occur. These units may communicate with processor 510 via, e.g., a USB link or a universal asynchronous receiver transmitter (UART) link. Or these units may couple to processor 510 via an interconnect via a Peripheral Component Interconnect Express™ (PCIe™) protocol in accordance with the PCI Express™ Specification Base Specification version 3.0 (published Jan. 17, 2007), or another such protocol such as a serial data input/output (SDIO) standard. Of course, the actual physical connection between these peripheral devices, which may be configured on one or more add-in cards, can be by way of the next generation form factor (NGFF) connectors adapted to a motherboard.

In addition, wireless wide area communications, e.g., according to a cellular or other wireless wide area protocol, can occur via a WWAN unit 556 which in turn may couple to a subscriber identity module (SIM) 557. In addition, to enable receipt and use of location information, a GPS module 555 may also be present. Note that in the embodiment shown in FIG. 5, WWAN unit 556 and an integrated capture device such as a camera module 554 may communicate via a given USB protocol such as a USB 2.0 or 3.0 link, or a UART or I²C protocol. Again the actual physical connection of these units can be via adaptation of a NGFF add-in card to an NGFF connector configured on the motherboard.

To provide for audio inputs and outputs, an audio processor can be implemented via a digital signal processor (DSP) 560, which may couple to processor 510 via a high definition audio (HDA) link. Similarly, DSP 560 may communicate with an integrated coder/decoder (CODEC) and amplifier 562 that in turn may couple to output speakers 563 which may be implemented within the chassis. Similarly, amplifier and CODEC 562 can be coupled to receive audio inputs from a microphone 565 which in an embodiment can be implemented via dual array microphones to provide for high quality audio inputs to enable voice-activated control of various operations within the system. Note also that audio outputs can be provided from amplifier/CODEC 562 to a headphone jack 564. Although shown with these particular components in the embodiment of FIG. 5, understand the scope of the present invention is not limited in this regard.

Embodiments can be used in many different environments. Referring now to FIG. 6, shown is a block diagram of an example system 600 with which embodiments can be used. As seen, system 600 may be a smartphone or other wireless communicator. As shown in the block diagram of FIG. 6, system 600 may include a baseband processor 610 which can include one or more cores. In general, baseband processor 610 can perform various signal processing with regard to communications, as well as perform computing operations for the device. In turn, baseband processor 610 can couple to a user interface/display 620 which can be realized, in some embodiments with inclusion of a hybrid touchpad as described herein. In addition, baseband processor 610 may couple to a memory system including, in the embodiment of FIG. 6 a non-volatile memory, namely a flash memory 630 and a system memory, namely a dynamic random access memory (DRAM) 635. As further seen, baseband processor 610 can further couple to a capture device 640 such as an image capture device that can record video and/or still images.

To enable communications to be transmitted and received, various circuitry may be coupled between baseband processor 610 and an antenna 690. Specifically, a radio frequency (RF) transceiver 670 and a wireless local area network (WLAN) transceiver 675 may be present. In general, RF transceiver 670 may be used to receive and transmit wireless data and calls according to a given wireless communication protocol such as 3G or 4G wireless communication protocol such as in accordance with a code division multiple access (CDMA), global system for mobile communication (GSM), long term evolution (LTE) or other protocol. In addition a GPS sensor 680 may be present. Other wireless communications such as receipt or transmission of radio signals, e.g., AM/FM and other signals may also be provided. In addition, via WLAN transceiver 675, local wireless signals, such as according to a Bluetooth™ standard or an IEEE 802.11 standard such as IEEE 802.11a/b/g/n can also be realized. Although shown at this high level in the embodiment of FIG. 6, understand the scope of the present invention is not limited in this regard.

The following examples pertain to further embodiments.

In one example, a system comprises a processor to execute instructions, a touchpad to receive touch data from a user, the touchpad coupled to the processor and including an engine to identify the touch data as a touch event or a mouse event and to communicate the identification of the touch event or the mouse event to an operating system (OS) that executes on the processor, and a memory coupled to the processor.

In an example, the touchpad includes a logical touchpad processor and a logical touch panel processor.

In an example, the touchpad is to register the logical touch panel processor and the logical touchpad processor to the OS.

In an example, the engine comprises firmware of the touchpad that is to execute on a controller of the touchpad, the controller comprising the logical touchpad processor and the logical touch panel processor.

In an example, the engine is to receive the touch data and to identify the touch data as the mouse event if the touch data corresponds to a single finger touch.

In an example, the engine is to dispatch the touch data to the logical touchpad processor when the touch data is identified as the mouse event, the logical touchpad processor to process the touch data and to forward the processed touch data to the OS.

In an example, the processed touch data includes position information having an offset with respect to an origin of the touchpad.

In an example, the engine is to receive the touch data and to identify the touch data as the touch event when the touch data is identified as a multi-finger touch or a boundary sliding touch.

In an example, the engine is to dispatch the touch data to the logical touch panel processor when the touch data is identified as the touch event, the logical touch panel processor to process the touch data and to forward the processed touch data to the OS.

In an example, the processed touch data includes absolute position information that associates the touch data with a position on a display of the system.

In an example, the display is a non-touch panel display and the touchpad to emulate a touch panel display.

In an example, the OS is to send the processed touch data directly to a user application without filtering in a filter driver.

In another example, a method comprises registering a logical touchpad processor and a logical touch panel processor of a hybrid touchpad of a system with an operating system (OS) of the system, the logical touchpad processor and the logical touch panel processor to execute on a controller of the hybrid touchpad, receiving touch data from a user of the system in an engine of the hybrid touchpad, determining a destination logical processor of the hybrid touchpad for the touch data based on analysis of the touch data in the engine, and dispatching the touch data to the logical touch panel processor for processing if the touch data is a single finger touch event, and dispatching the touch data to the logical touchpad processor for processing if the touch data is a multi-finger touch event.

In an example, processing the touch data in the logical touch panel processor includes converting the touch data into absolute position information of a location on a display of the system corresponding to a location on the touchpad of the touch data.

In an example, processing the touch data in the logical touchpad processor includes converting the touch data into offset position information corresponding to a location on the touchpad of the touch data.

In an example, the method further comprises sending the processed touch data including an indication of a touch event or a mouse event from the hybrid touchpad to the OS.

In an example, the OS forwards the processed touch data directly to an application when the processed touch data includes the identification of the touch event.

In an example, the method further comprises identifying the touch data as the single finger touch via firmware of the hybrid touchpad.

In an example, at least one machine readable medium comprising a plurality of instructions that in response to being executed on a computing device, cause the computing device to carry out a method according to any one or more of the above examples.

In an example, an apparatus comprises the means to perform a method according to any one or more of the above examples.

In another example, a system for handling touch data comprises means for registering a logical touchpad processor and a logical touch panel processor of a hybrid touchpad with an operating system (OS), means for receiving touch data from a user of the system corresponding to a touch panel event in an engine of the hybrid touchpad, and means for processing the touch data in the logical touchpad processor and sending the processed touch data to the OS for direct communication to an application.

In an example, the system further comprises means for converting the touch data into absolute position information of a location on a display of the system corresponding to a location on the touchpad of the touch data.

In an example, the system further comprises means for determining that the touch data corresponds to a touch panel event.

In an example, the system further comprises means for identifying that the touch data correspond to a mouse event when the touch data is a single finger touch and for identifying that the touch data correspond to the touch panel event when the touch data is a multi-finger touch or a boundary sliding touch.

In an example, the system further comprises means for sending the processed touch data to the OS with an identification of the multi-finger touch or the boundary sliding touch.

Understand that various combinations of the above examples are possible.

Embodiments may be used in many different types of systems. For example, in one embodiment a communication device can be arranged to perform the various methods and techniques described herein. Of course, the scope of the present invention is not limited to a communication device, and instead other embodiments can be directed to other types of apparatus for processing instructions, or one or more machine readable media including instructions that in response to being executed on a computing device, cause the device to carry out one or more of the methods and techniques described herein.

Embodiments may be implemented in code and may be stored on an at least one storage medium having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A system comprising:
a processor to execute instructions;
a touchpad to receive touch data from a user, the touchpad coupled to the processor, the touchpad including an engine to identify the touch data as a touch event or a mouse event and to communicate the identification of the touch event or the mouse event to an operating system (OS) that executes on the processor; and
a memory coupled to the processor.

2. The system of claim 1, wherein the touchpad includes a logical touchpad processor and a logical touch panel processor.

3. The system of claim 2, wherein the touchpad is to register the logical touch panel processor and the logical touchpad processor to the OS.

4. The system of claim 1, wherein the engine comprises firmware of the touchpad that is to execute on a controller of the touchpad, the controller comprising the logical touchpad processor and the logical touch panel processor.

5. The system of claim 1, wherein the engine is to receive the touch data and to identify the touch data as the mouse event if the touch data corresponds to a single finger touch.

6. The system of claim 5, wherein the engine is to dispatch the touch data to the logical touchpad processor when the touch data is identified as the mouse event, the logical touchpad processor to process the touch data and to forward the processed touch data to the OS.

7. The system of claim 6, wherein the processed touch data includes position information having an offset with respect to an origin of the touchpad.

8. The system of claim 1, wherein the engine is to receive the touch data and to identify the touch data as the touch event when the touch data is identified as a multi-finger touch or a boundary sliding touch.

9. The system of claim 8, wherein the engine is to dispatch the touch data to the logical touch panel processor when the touch data is identified as the touch event, the logical touch panel processor to process the touch data and to forward the processed touch data to the OS.

10. The system of claim 9, wherein the processed touch data includes absolute position information that associates the touch data with a position on a display of the system.

11. The system of claim 10, wherein the display is a non-touch panel display and the touchpad to emulate a touch panel display.

12. The system of claim 9, wherein the OS is to send the processed touch data directly to a user application without filtering in a filter driver.

13. A method comprising:
registering a logical touchpad processor and a logical touch panel processor of a hybrid touchpad of a system with an operating system (OS) of the system, the logical touchpad processor and the logical touch panel processor to execute on a controller of the hybrid touchpad;
receiving touch data from a user of the system in an engine of the hybrid touchpad;
determining a destination logical processor of the hybrid touchpad for the touch data based on analysis of the touch data in the engine; and
dispatching the touch data to the logical touch panel processor for processing if the touch data is a single finger touch event, and dispatching the touch data to the logical touchpad processor for processing if the touch data is a multi-finger touch event.

14. The method of claim 13, wherein processing the touch data in the logical touch panel processor includes converting the touch data into absolute position information of a location on a display of the system corresponding to a location on the touchpad of the touch data.

15. The method of claim 13, wherein processing the touch data in the logical touchpad processor includes converting the touch data into offset position information corresponding to a location on the touchpad of the touch data.

16. The method of claim 13, further comprising sending the processed touch data including an indication of a touch event or a mouse event from the hybrid touchpad to the OS.

17. The method of claim 16, wherein the OS forwards the processed touch data directly to an application when the processed touch data includes the identification of the touch event.

18. The method of claim 13, further comprising identifying the touch data as the single finger touch via firmware of the hybrid touchpad.

19. At least one computer-readable storage medium having instructions stored thereon for causing a system to:
register a logical touchpad processor and a logical touch panel processor of a hybrid touchpad of a system with an operating system (OS);
receive touch data from a user of the system corresponding to a touch panel event in an engine of the hybrid touchpad; and
process the touch data in the logical touchpad processor and send the processed touch data to the OS for direct communication to an application.

20. (canceled)

21. (canceled)

22. The at least one computer-readable storage medium of claim 19, further comprising instructions that cause the system to convert the touch data into absolute position information of a location on a display of the system corresponding to a location on the touchpad of the touch data.

23. The at least one computer-readable storage medium of claim 19, further comprising instructions that cause the system to determine in the engine that the touch data corresponds to a touch panel event.

24. The at least one computer-readable storage medium of claim 23, further comprising instructions that cause the system to identify that the touch data correspond to a mouse event when the touch data is a single finger touch and to identify that the touch data correspond to the touch panel event when the touch data is a multi-finger touch or a boundary sliding touch.

25. The at least one computer-readable storage medium of claim 24, further comprising instructions that cause the system to send the processed touch data to the OS with an identification of the multi-finger touch or the boundary sliding touch.
